(19) United States
(12) Patent Application Publication
(10) Pub. No.: US 2011/0121175 A1
(43) Pub. Date: May 26, 2011

(54) Mass Spectrometer

(75) Inventors: Motohide YASUNO, Kyoto-shi (JP); Kiyoshi OGAWA, Kizugawa-shi (JP); Nobuhiko NISHI, Kyoto-shi (JP)

(73) Assignee: SHIMADZU CORPORATION, Kyoto-shi (JP)

(21) Appl. No.: 12/948,608

(22) Filed: Nov. 17, 2010

(30) Foreign Application Priority Data
Nov. 20, 2009 (JP) 2009-264736

(51) Int. Cl. H01J 49/42

(52) U.S. Cl. 250/292

(57) ABSTRACT

The present invention aims at enhancing the ion transport efficiency in an ion guide for transporting ions into the subsequent stage while converging the ions by using a collisional cooling method and a radio-frequency electric field. In the present invention, a transport region through which ions pass is divided into an anterior region #1 having a region length L1 and an posterior region #2 having a, region length L2, and the intensity of the direct-current electric field can be set for each of the regions. A direct-current electric field for appropriately accelerating ions is formed in the region #1 so that the collisional cooling of ions is sufficiently performed while the ions are traveling through the region #1 and the ions are sufficiently converged around the ion optical axis C near the end point of the region #1. Meanwhile, in the region #2, a direct-current electric field weaker than that of the region #1 is formed in order to make the converged ions move to the exit plane without allowing them to be dispersed. Consequently, the ions are transported in a sufficiently converged form without remaining in the ion guide, which can achieve a high transport efficiency.

The present invention relates to a mass spectrometer. More precisely, it relates to an ion transport optical system for transporting an ion or ions in a mass spectrometer.

### BACKGROUND OF THE INVENTION

In general, a mass spectrometer is composed of: an ion source for ionizing a sample molecule or a sample atom; a mass analyzer for separating ions in accordance with their mass-to-charge ratio and detecting the ions; and an ion transport optical system, which is placed between the ion source and the mass analyzer, for transporting the ions generated by the ion source. In a mass spectrometer which performs an MS/MS analysis or which uses a reaction process of a reaction gas, a collision chamber is provided between the ion source and the mass analyzer. Such a collision chamber can be considered to be included in an ion transport optical system in that the collision chamber transports ions to the mass analyzer.

When ions are transported under an atmosphere where gas remains and the pressure is relatively high, such as in the case of a mass spectrometer using an ion source such as an electrospray ion (ESI) source or an inductively-coupled plasma (ICP) ion source, a radio-frequency ion guide, which uses an ion-convergence action of a radio-frequency electric field, is generally used as an ion transport optical system. This is because the radio-frequency ion guide has an advantage over electrostatic ion transport optical systems in that the decrease in the ion transport efficiency due to gas collision is smaller. It was previously thought that, in such a radio-frequency ion guide, the lower the pressure of the remaining gas was, i.e. the higher the degree of vacuum was, the higher the ion transport efficiency was. However, as disclosed by U.S. Pat. No. 4,963,736 and other documents, it has been found that the detection sensitivity actually increases by filling the internal space of the radio-frequency ion guide with a gas at an appropriate pressure. This effect is referred to as a collisional cooling.

The improvement in the detection sensitivity due to the collisional cooling is based on the following mechanism. That is, if a gas at an appropriate pressure exists in a pathway through which ions pass, ions to be analyzed which are injected into the pathway repeatedly collide with the gas. Therefore, as the ions travel forward, their kinetic energy gradually decreases, and the oscillation amplitude of the ions due to the action of the radio-frequency electric field also decreases. Consequently, the ions are converged around the central axis of the radio-frequency ion guide (or ion optical axis). As a result, the emittance of the ion beam ejected from the radio-frequency ion guide decreases, more ions are provided into the acceptance area of a mass separator such as a quadrupole mass filter, and the amount of ions which reach an ion detector also increases.

In a radio-frequency ion guide using the collisional cooling effect as previously described, main parameters that effect the ion transport efficiency are the kind of gas, the pressure of the gas, the length of a gas region (or the length of the radio-frequency ion guide), and the kinetic energy that ions entering the radio-frequency ion guide have.

Regarding the kind of gas for collisional cooling, a chemically stable gas is generally used. Particularly in an ICP-MS, in which an ion or ions having a low mass-to-charge ratio are analyzed, a gas having a small molecular weight, such as helium (He) or nitrogen (N₂), is preferable. The pressure of the gas, the length of the gas region, and the kinetic energy of the ions are dependent on the vacuum evacuation capacity (i.e. the performance of a vacuum evacuation pump), the size of the apparatus, the electric potential in the previous stage of the ion transport optical system, and other factors. By appropriately adjusting the aforementioned four parameters so as to operate the radio-frequency ion guide under the condition that the ion transport efficiency is maximum, a highly-efficient ion transportation can be achieved, which enhances the analysis sensitivity.

One of the problems that arise when a collisional cooling is used in a radio-frequency ion guide is that it takes time (ejection time) for ions to pass through the radio-frequency ion guide until they are ejected therefrom, and in an extreme case the ions remain in the radio-frequency ion guide. This occurs because collisional cooling causes a decrease in the kinetic energy of the ions not only in the direction perpendicular to the central axis of the radio-frequency ion guide but also in the ion optical axis direction (transport direction). As a result of the cooling, ions whose kinetic energy in the ion optical axis direction has been decreased take a long time to be ejected (i.e. to exit from the ion guide), which may cause a generation of a ghost peak in the chromatogram when different samples are sequentially analyzed by using, for example, a liquid chromatograph mass spectrometer or other apparatus. Further, if the ion ejection time from the radio-frequency ion guide is extremely long and ions remain inside, the ions may spatially disperse due to the space-charge effect, causing a decrease in the ion transport efficiency.

One known method to solve the aforementioned problem is to generate a direct-current accelerating electric field having a potential gradient in the ion optical axis direction inside a radio-frequency ion guide and accelerate ions whose kinetic energy in the ion optical axis direction has been decreased due to a collisional cooling to increase the rate of ejection. As a method for generating such a direct-current electric field in the ion optical axis direction, the following methods are known (refer to U.S. Pat. No. 5,847,386 and No. 6,462,338 and other documents, for example).

(1) In a radio-frequency ion guide composed of multipole rod electrodes, disposing the rod electrodes at a tilt which are normally arranged parallel to the ion optical axis, in order to form a direct-current potential gradient in the ion optical axis direction.

(2) Forming a continuous resistive layer in the ion optical axis direction on the surface of each rod electrode of the multipole rod electrodes, and giving a direct-current potential difference between the two ends of the layer to form a direct-current potential gradient in the ion optical axis direction.

(3) Using virtual multipole rod electrodes in which each rod electrode is composed of a plurality of small electrodes divided in the ion optical axis direction, and applying a different direct-current voltage to each of the divided small electrodes to form a direct-current potential gradient in the ion optical axis direction.

(4) Placing auxiliary rod electrodes having any one of the configurations (1) through (3) between the adjacent rod electrodes of the multipole rod electrodes to form a direct-current potential gradient in the ion optical axis direction with these auxiliary rod electrodes.

As previously described, forming an accelerating direct-current electric field in the ion optical axis direction in a radio-frequency ion guide can shorten the ion ejection time. Such a method is useful not only in the case where ions are transported to the subsequent stage in the atmosphere of relatively high pressure due to much remaining gas, but also in the case where a precursor ion or ions are made to collide with a collision gas to generate product ions by the collision induced dissociation (CID) inside a collision chamber in a triple quadrupole mass spectrometer.

The direct-current electric field in the ion optical axis direction may be sometimes used for a purpose other than shortening the ejection time of the ions. In the mass spectrometer disclosed in Japanese Unexamined Patent Application Publication No. 2002-184349 for example, ions that have been collisional-cooled are once stored in a posterior section of the ion guide, and the stored ions are collectively sent into an ion trap or a time-of-flight mass spectrometer in the subsequent stage in a pulsed fashion (in a packeted form) at a predetermined timing. In this case, the effect of the direct-current electric field in the ion optical axis direction is to push the ions anteriorward and hold them back at the posterior end in order to store the ions inside the ion guide, and to simultaneously accelerate all the ions when this holdback operation is cancelled.

### SUMMARY OF THE INVENTION

In recent years, in a chromatograph mass spectrometer in which a liquid chromatograph or a gas chromatograph and a mass spectrometer are combined, a demand for detecting a minute amount of components in a continuously supplied sample has been greatly increasing, and therefore it is becoming necessary to further increase the ion transport efficiency in the ion transport optical system. In a radio-frequency ion guide which uses a collisional cooling method, even in the case where a direct-current electric field in the ion optical axis direction is used, its main purpose is to shorten the ion ejection time, to temporally store the ions, and so on. Hence, the direct-current electric field is not necessarily used effectively in terms of enhancing the ion transport efficiency.

The present invention has been developed in view of the aforementioned problems, and the objective thereof is to appropriately utilize a direct-current electric field in the ion optical axis direction to achieve a high ion transport efficiency and improve the analysis sensitivity in a mass spectrometer including a radio-frequency ion guide for transporting sequentially injected ions to the subsequent stage by using a radio-frequency electric field and the collisional cooling method.

To cool ions by using a collision with gas, it is necessary that the ions proceed at a certain degree of speed. To prevent ions from remaining inside the ion guide, it is necessary to give energy to them by an accelerating electric field. However, if ions which have been sufficiently cooled by collision and which are converged around the ion optical axis are forcedly given kinetic energy by the accelerating electric field, the ions collide with a cooling gas and have a velocity component in the direction orthogonal to the ion optical axis; therefore, the ions are adversely dispersed (or move away from the ion optical axis). Given this problem, the inventors of the present invention have conceived a new idea for setting a direct-current electric field in an ion guide. According to this idea, the ion transport region, through which ions pass, is not viewed as a single unit but is divided into plural regions along the ion optical axis direction, and an optimal direct-current electric field is created in each of these regions to improve the ion transport efficiency for each region.

The present invention achieved to solve the aforementioned problem provides a mass spectrometer including an ion guide for transporting ions through an ion transport region extending from an ion entrance plane to an ion exit plane along an ion optical axis while converging the ions by using a radio-frequency electric field and collisional cooling, wherein the ion transport region is divided into a plurality of divided transport regions, the ion guide forms a direct-current electric field for accelerating the ions, the direct-current electric field has a different potential gradient in an ion optical axis direction for each of the divided transport regions, and the intensity of the direct-current electric field in the divided transport regions decreases as the ions move forward.

That is, in the mass spectrometer according to the present invention, the ion transport region may be divided into N divided transport regions (where N is an integer equal to or more than two), and the intensity of the direct-current electric field in the ion optical axis direction in each of the divided transport regions may be set in such a manner that En>En+1 for 1≦n≦N−1 is satisfied given that En is the intensity of the direct-current electric field in the ion optical axis direction in the n^{th} divided transport region from the side of the ion entrance plane.

In the aforementioned ion guide, the gas (or cooling gas) used for the collisional cooling is either air and a vaporized solvent gas which are injected with ions or a gas actively injected from the outside to cause collisional excitations and reactions. In the case of using an atmospheric pressure ion source, such as an electrospray ionization (ESI) ion source, an inductively-coupled plasma (ICP) ion source, or an atmospheric pressure chemical ionization (APCI) ion source, a multi-stage differential evacuation system is often used. In this case, the gas pressure inside a vacuum chamber near the ion source is relatively high. If the ion guide is provided inside such a vacuum chamber, a gas injected with ions from the chamber in the previous stage can be used as a cooling gas. If the ion guide is provided in a collision chamber for dissociating ions by the collision-induced dissociation to perform an MS/MS analysis, the collision gas itself serves as a cooling gas. In addition, in an ICP-MS, a reactant gas injected for the sake of eliminating interfering ions also serves as a cooling gas.

The simplest and the most basic configuration of the ion guide used in the mass spectrometer according to the present invention is in the case where N=2, i.e. the case where the ion transport region is divided into two divided transport regions. In this case, the anterior divided transport region is a region in which a collisional cooling of ions proceeds, and the posterior divided transport region is a region in which ions that have been sufficiently cooled by the collisional cooling are converged around the ion optical axis and from which the ions are sent to the outside.

When entering the ion guide, ions have a somewhat large amount of kinetic energy. Therefore, ions that collide with a cooling gas in the anterior portion of the ion guide may have a relatively large amount of kinetic energy in the direction orthogonal to the ion optical axis direction (or the radial direction) depending on the angle of collision. In order to efficiently transport such ions to the downstream area of the ion guide, ions headed in the radial direction need to be accelerated in the ion optical axis direction. To this end, in the anterior divided transport region of the ion guide in which a collisional cooling proceeds, it is necessary to form a relatively large direct-current electric field in the ion optical axis direction. Meanwhile, ions that have traveled to the posterior divided transport region of the ion guide have a small amount of kinetic energy both in the ion optical axis direction and in the radial direction due to the collisional cooling in the preceding phase. If these ions are accelerated by a large direct-current electric field from this state, a portion of the kinetic energy will be distributed from the ion optical axis direction to the radial direction by the collision of gases. This reduces the effect of converging the ion beam, resulting in a relative decrease in the ion transport efficiency. Given this factor, in order that sufficiently collisional-cooled ions are ejected from the ion guide while remaining converged around the ion optical axis direction as much as possible, the intensity of the direct-current electric field in the ion optical axis direction in the divided transport region near the exit plane of the ion guide is relatively decreased compared to that in the anterior divided transport region.

The electric field intensity as referred to herein is a value obtained by |ΔV/L|, where ΔV is the potential difference between the two ends of the divided transport region in the ion optical axis direction, and L is the length of the divided transport region in the ion optical axis direction.

In the mass spectrometer according to the present invention, ions which have been sufficiently converged around the ion optical axis by a collisional cooling are not spatially dispersed and are ejected from the ion guide to be sent into the subsequent stage. Furthermore, the ions are prevented from remaining inside the ion guide due to an excessive reduction of the kinetic energy of the ions by a collisional cooling. Therefore, compared to conventional apparatuses, the ion transport efficiency is further increased, and a larger amount of ions can be transported into the acceptance area of a mass separator in the subsequent stage, such as a quadrupole mass spectrometer (or mass filter); consequently, the ion detection sensitivity can be enhanced.

In order to prevent dispersion of the ions converged around the ion optical axis by a collisional cooling, it is preferable that the intensity of the direct-current electric field in the ion optical axis direction in the divided transport region placed on the side of the ion exit plane is set to be as small as possible, preferably zero or almost a negligible degree (i.e. practically zero), and the ions are extracted from the ion guide by the action of the electric field of an electrode or electrodes provided in the subsequent stage of the ion guide. That is, it is preferable that ions are ejected not by the action of the direct-current electric field formed by the ion guide itself, but by the action of the direct-current electric field formed by the electrodes in the subsequent stage. In order to efficiently extract ions with such an extraction electric field, it is necessary that the extraction electric field effectively enters the posterior divided transport region of the ion guide (to the degree that a potential gradient for extraction can be formed). To this end, it is preferable that the length of the rearmost divided transport region of the ion guide is not extremely long compared to the diameter of the opening of the ion guide.

In the mass spectrometer according to the present invention, a variety of specific configurations can be used to divide the ion transport region into a plurality of regions along the ion optical axis and to form direct-current electric fields having a different intensity for each of the divided transport regions. That is, as the configuration of the electrode unit provided in the atmosphere in which a cooling gas for a collisional cooling exists, a variety of conventionally known configurations capable of forming a direct-current electric field having a potential gradient in the ion optical direction can be adopted.

For example, one of the following configurations can be used as the electrode unit: virtual multipole rod electrodes in which a plurality of virtual rod electrodes are disposed around the ion optical axis, each of the virtual rod electrodes being composed of a plurality of electrode plates (or metal blocks having a thickness which cannot be described as a “plate”) aligned along the ion optical axis; multipole rod electrodes composed of a plurality of substantially cylindrical resistive rod electrodes disposed around the ion optical axis, with a resistive layer on their surface; and a configuration in which virtual rod electrodes or resistive rod electrodes as previously described are placed as auxiliary rod electrodes between adjacent main rod electrodes for forming a radio-frequency electric field.

Alternatively, in the case where the transport region is divided into three or more divided transport regions, the intensity of the direct-current electric field may be appropriately set for each of the divided transport regions. In this case, assuming that the transport region is divided into N divided transport regions, the electric field intensity is set for the N−1 divided transport regions from the side of the ion entrance plane in such a manner that the convergence of ions by a collisional cooling finishes around the boundary between the N−1^{st} divided transport region and the N^{th} divided transport region. Further, the intensities of the electric field in the N−1 divided transport regions may be appropriately distributed so that the ion transport efficiency for the ions for which a collisional cooling is in progress is optimal. A typical example where N≧3 is appropriate is an off-axis ion guide in which the ion optical axes in the ion guide are out of alignment. In an off-axis ion guide, the optimal direct-current electric field in the ion optical axis direction is different between in the area where ions injected from the injection end substantially travel straight (excluding the oscillation by the radio-frequency electric field) and in the off-axis area having an optical axis oblique to the optical axis of the ions traveling straight. Given this factor, it is possible that the area where ions travel straight and the off-axis area are each regarded as an individual different divided transport region, and the intensities of their direct-current electric fields are independently set to enhance the ion transport efficiency of the off-axis ion guide.

### BRIEF DESCRIPTION OF THE DRAWINGS

FIG. 1 is a schematic configuration diagram of the ion guide and a pattern diagram of the direct-current electric field in an embodiment (the first embodiment) of the mass spectrometer according to the present invention.

FIG. 2 is a schematic configuration diagram of the mass spectrometer of the first embodiment.

FIG. 3 is a schematic configuration diagram of the ion guide according to a modification example of the first embodiment.

FIG. 4 is a schematic configuration diagram of the ion guide according to a modification example of the first embodiment.

FIG. 5 is a schematic configuration diagram of the ion guide according to a modification example of the first embodiment.

FIG. 6 is a schematic configuration diagram of the mass spectrometer of the second embodiment.

FIG. 7 is a schematic configuration diagram of the ion guide according to the second embodiment.

FIG. 8 is a diagram showing the result of an actual measurement in the configuration of the second embodiment.

FIG. 9 is a diagram showing the result of a simulation of the orbit of ions.

FIG. 10 is a diagram showing the result of an actual measurement of the relationship between the gas pressure of the cooling gas (He) and the ion intensity.

### EXPLANATION OF THE NUMERALS

1 . . . Ion Guide

6 . . . Off-Axis Ion Guide

10, 60 . . . Electrode Unit

100 . . . Circuit Unit

101 . . . Direct-Current Power Supply

102 . . . Radio-Frequency Power Supply

103 . . . Controller

104 . . . Network Resistance

105 . . . Capacitor

11, 12, 13, 14, 61, 62, 63, 64 . . . Virtual Rod Electrode

21 . . . ESI Probe

22 . . . Sampling Cone

23 . . . Skimmer

24 . . . First Intermediate Vacuum Chamber

25 . . . Second Intermediate Vacuum Chamber

26 . . . High-Vacuum Chamber

27 . . . Quadrupole Mass Filter

28 . . . Ion Detector

29 . . . Cooling Gas Supply Pipe

31 . . . Main Rod Electrode

41 . . . Rod Electrode

411, 412, 413 . . . Conductive Material Layer

414, 415, 416, 417 . . . Resistive Layer

50 . . . Plasma Torch of ICP ion source

51 . . . Extraction Electrode

52 . . . Aperture Electrode

### DETAILED DESCRIPTION OF PREFERRED EMBODIMENTS

### First Embodiment

An embodiment (the first embodiment) of the mass spectrometer according to the present invention will be described with reference to the accompanying drawings.

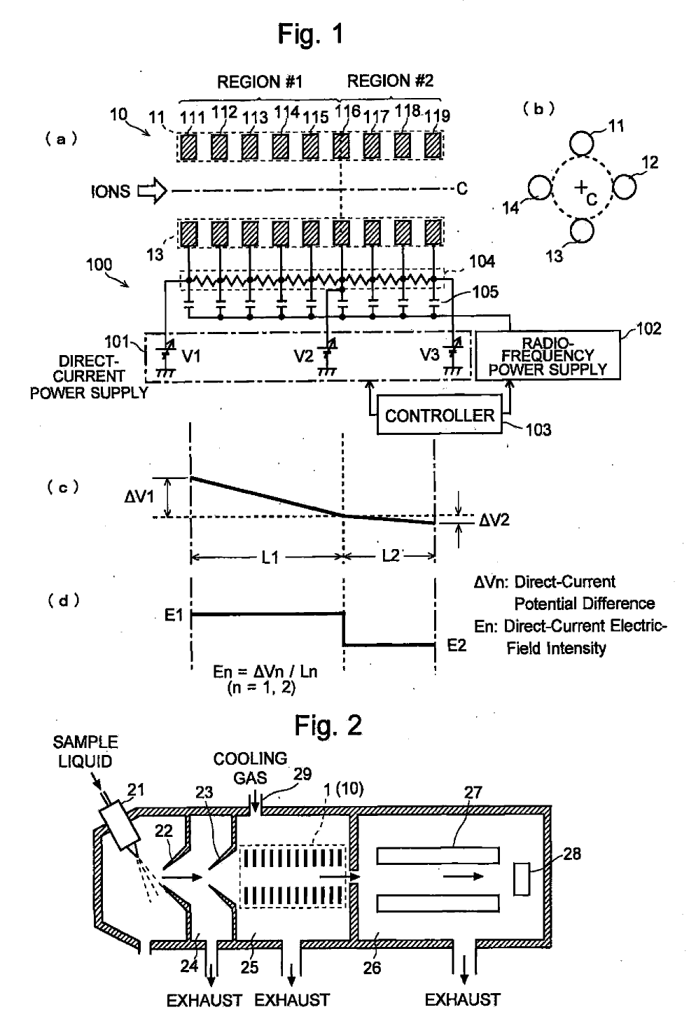

FIG. 2 is a schematic configuration diagram of the mass spectrometer according to the first embodiment, and FIG. 1 is a schematic configuration diagram of the ion guide in the mass spectrometer of the present embodiment and diagrams for explaining the operation thereof. In this mass spectrometer, an ESI ion source is used as an atmospheric pressure ion source.

As shown in FIG. 2, in this mass spectrometer, a sample liquid is injected to the ESI probe 21, and atomized into a space at substantially atmospheric pressure from the probe 21, so that the sample components are ionized. The generated ions are introduced into the first intermediate vacuum chamber 24 thorough the sampling cone (nozzle), and then introduced into the second intermediate vacuum chamber 25 through the skimmer 23. In the second intermediate vacuum chamber 25, the ion guide 1, which will be described later, is provided. While being converged by this ion guide 1, the ions are sent to the high-vacuum chamber 26 in the subsequent stage. In the high-vacuum chamber 26, the quadrupole mass filter 27 as a mass separator and the ion detector 28 are provided. Only the ions having a specific mass-to-charge ratio pass through the quadrupole mass filter 27 and arrive at the ion detector 28, to be detected by this detector.

In the aforementioned configuration, the ESI probe 21 is placed at substantially atmospheric pressure, and the inside of the high-vacuum chamber 26 is maintained at a high vacuum atmosphere by a vacuum pump, such as a turbo molecular pump, which is not shown. Each of the first intermediate vacuum chamber 24 and the second intermediate vacuum chamber 25, which are placed between the ESI probe 21 and the high-vacuum chamber 26, is also vacuum-evacuated by a vacuum pump which is not shown, forming a multistage differential pumping system in which the degree of vacuum is increased in a stepwise manner toward the high vacuum chamber 26. In general, the gas pressure in the first intermediate vacuum chamber 24 is approximately 10 through 100 [Pa] and the gas pressure in the second intermediate vacuum chamber 25 is approximately 0.1 through 1 [Pa]. However, since a cooling gas such as He is supplied to the second intermediate vacuum chamber 25 through the cooling gas supply tube 29, the gas pressure in the second intermediate vacuum chamber 25 is increased to approximately 1 through 10 [Pa].

Next, the ion guide 1, which is characteristic of the mass spectrometer of the present embodiment, will be described with reference to FIG. 1. FIG. 1(a) is a schematic configuration diagram of an electrode unit 10 and a circuit unit 100 of the ion guide 1, FIG. 1(b) shows the electrode unit 10 viewed from the ion entrance side, FIG. 1(c) is a potential gradient diagram schematically showing the direct-current electric potential on the ion optical axis C, and FIG. 1(d) is a pattern diagram schematically showing the electric field intensity of each divided transport region.

As is shown in FIGS. 1(a) and 1(b), the ion guide 1 includes the electrode unit 10 composed of four virtual rod electrodes 11, 12, 13, and 14, and the circuit unit 100 for applying a voltage to the electrode unit 10. The four virtual rod electrodes 11 through 14 are disposed in such a manner that they touch the periphery of a cylinder whose central axis is the ion optical axis C and that two virtual rod electrodes adjacent in the circumferential direction are placed at an interval of 90 degrees. Each of the virtual rod electrodes 11 through 14 is composed of a plurality of (nine in this example) substantially disk-shaped electrode plates (only 111 through 119 are shown in FIG. 1(a)) arranged at predetermined intervals along the ion optical axis C.

A voltage can be independently applied to each of the electrode plates (e.g. 111 through 119) composing one virtual rod electrode 11, 12, 13, or 14. The electrode plates adjacent in the ion optical axis C direction are: connected with resistors having the same resistance value included in a network resistance 104. In addition, each of the electrode plates is connected to a radio-frequency power supply 1Q2 through a capacitor 105 for interrupting a direct current, and the same radio-frequency voltage is applied to all the electrode plates (e.g. 111 through 119). The first, sixth, and ninth (ion exit) electrode plates (e.g. 111, 116, and 119) from the ion entrance plane side are each connected to the direct-current power supply 101, and mutually different direct-current voltages are applied to them from the direct-current power supply 101 under the control of the controller 103.

Although not shown, the same radio-frequency voltage V_{RF}·cos ωt is applied to the electrode plates that belong to two virtual rod electrodes 11 and 13 facing across the ion optical axis C among the four virtual rod electrodes 11 through 14, and the radio-frequency voltage−V_{RF}·cos ωt having a reversed polarity is applied to the electrode plates that belong to the other two virtual rod electrodes 12 and 14. Regarding the direct-current voltages, the same direct-current voltage is applied to four electrode plates which belong to the four virtual rod electrodes 11 through 14, respectively, and lie on the same plane orthogonal to the ion optical axis C.

As previously described, the radio-frequency voltages applied to the four rod electrodes 11 through 14 form what is called a quadrupole radio-frequency electric field in the space surrounded by the four rod electrodes 11 through 14, i.e. in the ion transport region. Ions injected to the electrode unit 10 of the ion guide 1 travel while oscillating due to the action of this radio-frequency electric field. The action of this radio-frequency electric field is the same as that of conventional radio-frequency ion guides.

In each of the virtual rod electrodes 11 through 14, a direct-current voltage V1 is applied to the first electrode plate (e.g. 111) from the direct-current power supply 101, a direct-current voltage V2 is applied to the sixth electrode plate (e.g. 116) from the direct-current power supply 101, and a direct-current voltage V3 is applied to the ninth electrode plate (e.g. 119) from the direct-current power supply 101. Since resistors are each inserted between electrode plates adjacent in the direction of the ion optical axis C as previously described, a voltage in which an electric potential obtained by dividing the voltage difference of V2−V1=ΔV1 by each resistance ratio is added to V2 is applied to each of the second through fifth electrode plates (e.g. 112 through 115). Accordingly, in the first divided transport region #1, which extends from the first to the sixth electrode plates (e.g. 111 through 116), a direct-current electric field is formed in which the direct-current electric potential on the ion optical axis C has the gradient as illustrated in FIG. 1(c). Meanwhile, a voltage in which an electric potential obtained by dividing the voltage difference of V3−V2=ΔV2 by each resistance ratio is added to V3 is applied to each of the seventh and eighth electrode plates (e.g. 117 and 118). Accordingly, in the second divided transport region #2, which extends from the sixth to ninth electrode plates (e.g. 116 through 119), a direct-current electric field is formed in which the direct-current electric potential on the ion optical axis C has such a gradient as illustrated in FIG. 1(c).

As shown in FIG. 1(c), the schematic electric potential distribution on the ion optical axis C has a linear shape both in the first divided transport region #1 and in the second divided transport region #2. The slope of each line is determined by the potential difference. The slope of the potential gradient in the first divided transport region #1 is ΔV1/L1, and the slope of the potential gradient in the second divided transport region #2 is ΔV2/L2. L1 and L2 are the region length of the respective divided transport regions. These ΔV1/L1 and ΔV2/L2 represent the intensity of the direct-current electric field in the respective divided transport regions. L1 and L2 are a parameter determined by the configuration of the electrode unit 10, whereas ΔV1 and ΔV2 are a parameter determined by the applied direct-current voltages V1, V2, and V3. This allows an appropriate setting of the intensity of the direct-current electric field by a command from the controller 103. Therefore, as shown in FIG. 1(d), the application voltages V1, V2, and V3 are set so that the intensity of the electric field in the first divided transport region #1 is larger than that in the second divided transport region #2, i.e. so that ΔV1/L1>ΔV2/L2 is satisfied. In addition, the voltages V1, V2, and V3 are set so that the following effect is exerted.

In the mass spectrometer of the present embodiment, ions are continuously produced in the ESI probe 21. After entering the second intermediate vacuum chamber 25, the cations enter the electrode unit 10 of the ion guide 1. The ions travel in the first divided transport region #1 while being oscillated by the radio-frequency electric field. During the travel, the ions repeatedly collide with the cooling gas and gradually lose their kinetic energy. Although a portion of the kinetic energy is distributed to the direction orthogonal to the ion optical axis C direction due to the collisions, the ions are accelerated in the ion optical axis C direction by the relatively large direct-current electric field. Ions can keep enough energy by the electric field in the ion optical axis C to reach the transport region #2 and consequently converged around the ion optical axis C at the transport region #2. If the potential difference ΔV1 is appropriately set with respect to the region length L1, the ions are sufficiently collisional-cooled near the end of the first divided transport region #1, to be converged around the ion optical axis C.

When the ions enter the second divided transport region #2, the potential gradient in the ion optical axis C direction suddenly becomes gradual, which accelerates the ions less. Hence, the ions, which are converged around the ion optical axis C, keep advancing relatively slowly. Although the ions collide with the cooling gas also at this point in time, the collision causes only a small amount of energy to be distributed toward the direction away from the ion optical axis C because the kinetic energy that the ions originally have is not large. Consequently, a capturing effect by the radio-frequency electric field sufficiently operates, so that the ions will hardly be dispersed when they exit from the exit plane to be sent to the high-vacuum chamber 26 in the subsequent stage. Hence, the potential difference ΔV2 needs only to be a potential difference capable of providing such an amount of energy that enables ions to pass through the second divided transport region #2 having the region length L2.

As previously described, in the ion guide 1 in this mass spectrometer, a relatively strong direct-current accelerating electric field is formed in the first divided transport region #1 in the anterior portion. Therefore, the collisional cooling effect is sufficiently exerted, so that ions are converged around the ion optical axis C. The strong field also prevents the ions from competently losing their energy and remaining along the way. Meanwhile, a relatively weak direct-current accelerating electric field is formed in the second divided transport region #2 in the posterior portion, thereby preventing the dispersion of the ions which have been previously converged sufficiently around the ion optical and, at the same time, assuredly moving the ions to the ion exit plane. In this manner, ions can be transferred to the subsequent stage with a high level of transport efficiency.

As previously described, the direct-current electric field formed in the first divided transport region #1 has the effect of providing a kinetic energy to ions to prevent them from remaining in the region. However, this ion guide 1 does not have a configuration intended to shorten the ion ejection time. For the short ejection time, in the ion ejection rate, it is preferable that the intensity E2 of the direct-current electric field in the ion optical axis C direction of the second divided transport region #2 be larger than the intensity E1 of the direct-current electric field in the ion optical axis C direction of the first divided transport region #1. This is because providing a stronger accelerating electric field in the posterior portion, where ions slow down, is effective in shortening the ejection time. However, the findings from experimental results, which will be described later, and from a qualitative analysis of the behavior of ions show that the setting of E2>E1 exerts an adverse effect in terms of the ion transport efficiency. The setting of E2<E1 as in the aforementioned embodiment is effective in increasing the ion transport efficiency, although it is disadvantageous in terms of shortening the ejection time.

As will be described later, it is clear that, in an actual apparatus, the values of the voltages V1, V2, and V3, which determine the electric field intensities E1 and E2, can be experimentally determined in advance.

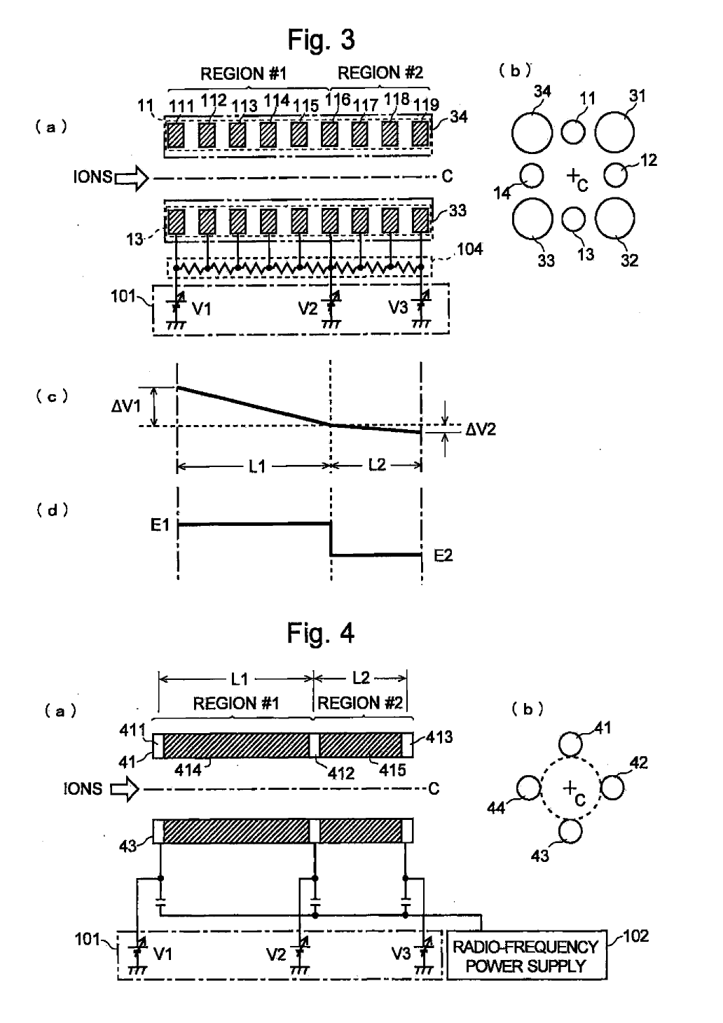

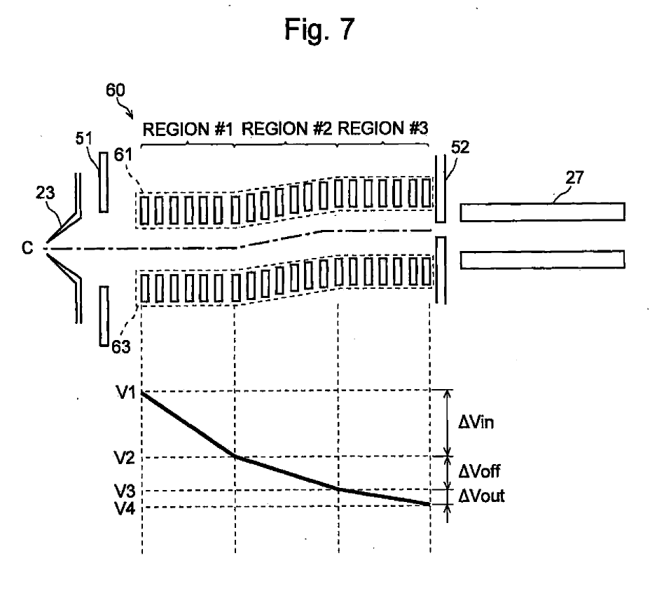

It should be noted that the potential distribution (or gradient) shown in FIG. 1(c) and the electric field intensity shown in FIG. 1(d) are not exact since, in the electrode unit 10, the ion optical axis C and the electrode plates are separated and there is an effect of an edge field at both ends along the ion optical axis C ; they are simplified figures prepared solely for easy understanding. This is the same for FIG. 3(c), FIG. 3(d), and FIG. 7, which will be referred to later.

### Modification Example of the First Embodiment

A modification example of the ion guide 1 which was described in the aforementioned first embodiment is shown in FIGS. 3 through 5.

In the first embodiment, a radio-frequency voltage which is superimposed on direct-current voltage is applied to virtual rod electrodes 11 through 14. Each voltage forms a radio-frequency electric field and a direct-current electric field in the space surrounded by the virtual rod electrode 11 through 14, respectively. Meanwhile, in the configuration shown in FIG. 3, auxiliary rod electrodes 11 through 14 for forming a direct-current electric field, which are composed of virtual rod electrodes similar to those in the first embodiment, are provided in addition to main rod electrodes 31 through 34 for forming a radio-frequency electric field. The main rod electrodes 31 through 34 are each made of a cylindrical (or column-shaped) conductor and have a typical quadrupole rod type configuration in which four electrodes are provided in such a manner as to surround the ion optical axis C. Direct-current voltages are individually applied from the direct-current power supply 101 to each electrode plate of the auxiliary rod electrodes 11 through 14 through the network resistance 104. Accordingly, as in the first embodiment, a direct-current electric field having a predetermined intensity is formed in the two divided transport regions #1 and #2.

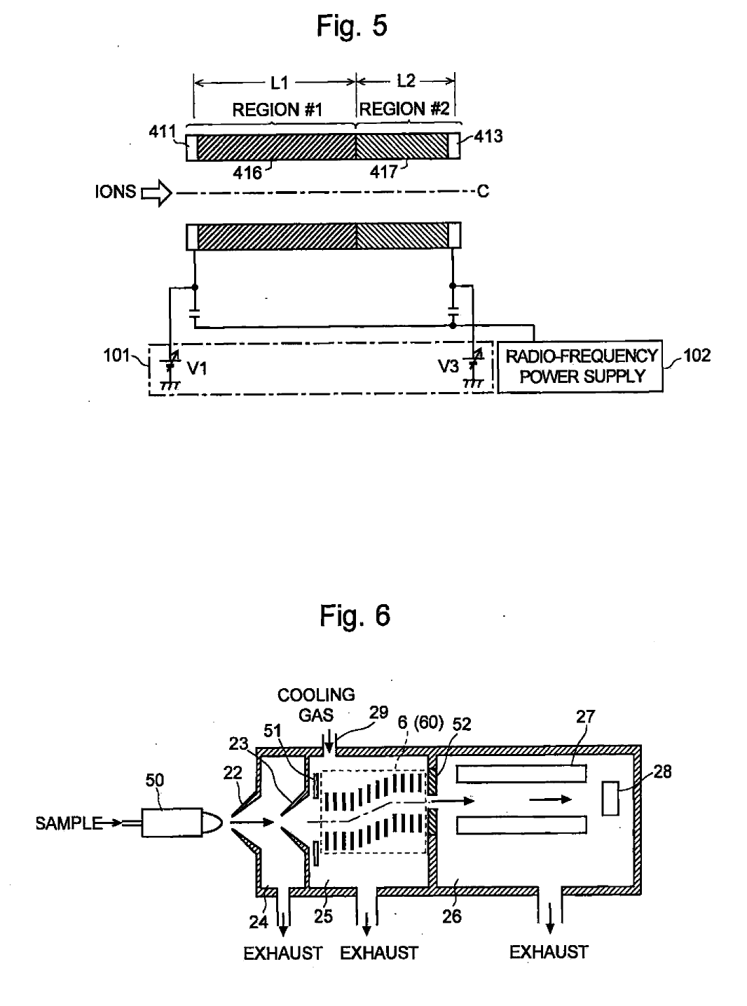

FIGS. 4 and 5 show an example in which rod electrodes with a resistive layer formed on the surface thereof are used, in place of virtual rod electrodes.

In the example of FIG. 4, in four rod electrodes 41 through 44 disposed in such a manner as to surround the ion optical axis C, conductive layers (e.g. 411, 412, and 413) are formed at the following three portions: on the surface of both ends of the cylindrical insulator and an intermediate portion thereof (at a position where the distance from the ion entrance plane side is approximately L1 and the distance from the ion exit plane side is approximately L2). Resistive layers (e.g. 414 and 415) are continuously formed between the adjacent conductive layers. The resistive layer is formed by applying a resistive material, with a given thickness, having a predetermined resistivity on the surface of the insulator. Therefore, this is equivalent to the configuration in which a resistance is connected between the conductive layers 411 and 412 and another resistance is connected between the conductive layers 412 and 413. By applying a predetermined voltage to each of the conductive layers 411, 412, and 413 from the direct-current power supply 101, a direct-current electric field having a predetermined intensity can be formed in the two divided transport regions #1 and #2, as in the first embodiment.

The example of FIG. 5 is similar to that of FIG. 4. However, the intermediate conductive layer 412 is not provided in each of the rod electrodes 41 through 44, and continuous resistive layers 416 and 417 are provided between the conductive layers 411 and 413 at both ends. Although the resistive layers 416 and 417 are continuous with each other, the resistive layer 416 in the anterior portion and the resistive layer 417 in the posterior portion, with the boundary at a distance of approximately L1 from the ion entrance plane side (and a distance of approximately L2 from the ion exit plane side), are each composed of a resistive material having a different resistivity (or composed of the same resistive material with a different coating thickness) and hence have different resistance values per unit length. By appropriately adjusting these resistance values per unit length and by applying a predetermined voltage to each of the conductive layers 411 and 413 from the direct-current power supply 101, a direct-current electric field having a predetermined intensity is formed in the two divided transport regions #1 and #2, as in the first embodiment.

The rod electrodes shown in FIGS. 4 and 5 may be used as the auxiliary rod electrodes in the configuration shown in FIG. 3.

### Second Embodiment

Next, an ICP-MS which is another embodiment (the second embodiment) of the mass spectrometer according to the present invention will be described. FIG. 6 is a schematic configuration diagram of this ICP-MS, and FIG. 7 is a schematic configuration diagram of the ion guide used in this ICP-MS and diagrams for explaining the operation thereof. The same or corresponding components as in the aforementioned first embodiment are indicated with the same numerals and the detailed explanations are omitted.

In this ICP mass spectrometer, a sample component is ionized in a plasma flame generated by the plasma torch of ICP ion source 50 under a substantially atmospheric pressure, and generated ions are injected to the ion guide placed in the second intermediate vacuum chamber 25 through the sampling cone 22 and the skimmer 23. In this configuration, an off-axis ion guide 6 is provided in order to prevent the light emitted from the plasma flame from entering the second intermediate vacuum chamber 25 with ions. In the aforementioned first embodiment and the modification example thereof, the ion transport region by the ion guide 1 is divided into two regions in the ion optical axis C direction, whereas in the ion guide 6 in this second embodiment, the number of division is three. The electrode unit 60 of this ion guide 6 is, as in the first embodiment, composed of four virtual rod electrodes 61 through 64 (however, only the virtual rod electrodes 61 and 63 are shown in FIGS. 6 and 7) provided in such a manner as to surround the ion optical axis C.

As shown in FIG. 7, in the electrode unit 60 of the off-axis ion guide 6, the ion optical axis on the ion entrance plane and the ion optical axis on the ion exit plane are not on the same straight line. Ions are captured with the radio-frequency electric field and bent while traveling. On the other hand, neutral particles and lights which enter with the ions are not affected by the electric field and travel straight. Accordingly, the neutral particles and lights, which may cause a noise, do not arrive at the ion exit opening and can be eliminated. In this ion guide 6, the ion transport region through which ions pass is divided into the following three regions: an entrance straight-through area where ions which have entered from the entrance plane travel straight; an off-axis area where the ions slide in an oblique direction; and an exit straight-through area where the ions travel straight before exiting from the exit plane. The entrance straight-through area corresponds to the first divided transport region #1, the off-axis area to the second divided transport region #2, and the exit straight-through area to the third divided transport region #3.

Although the illustration of the circuit unit is omitted in FIG. 7, just as the intensities of the direct-current electric fields of the two divided transport regions #1 and #2 can be individually controlled in the first embodiment, so can be individually controlled the intensities of the direct-current electric fields of the three divided transport regions #1, #2, and #3 in this second embodiment. The intensities of the direct-current electric fields of the first divided transport region #1 and the second divided transport region #2 are set in such a manner that the ions will be sufficiently cooled due to collisions with a cooling gas and converged around the ion optical axis C before they come in the vicinity of the end point of the second divided transport region #2. Meanwhile, the intensity of the direct-current electric field of the third divided transport region #3 is set to be relatively low so that the ions which have been converged around the ion optical axis C just before the third divide transport region #3 by the collisional cooling can be ejected without being dispersed.

In this example, in order to extract ions from the previous stage through the orifice of the skimmer 23 and accelerate and inject them to the electrode unit 60 of the ion guide 6, an extraction electrode 51 is provided between the electrode unit 60 and the skimmer 23. Between the exit plane of the electrode unit 60 and the quadrupole mass filter 27 in the subsequent stage, an aperture electrode 52 is provided, which serves also as a partition wall for separating the intermediate vacuum chamber and the high-vacuum chamber. To this aperture electrode 52, a direct-current voltage which is lower than V4 is applied. The electric field formed by this direct-current voltage enters the inside of the electrode unit 60 (or the space surrounded by the four virtual rod electrodes 61 through 64) from the exit plane of the electrode unit 60, and exerts the effect of extracting ions from the electrode unit 60 and sending them to the quadrupole mass filter 27.

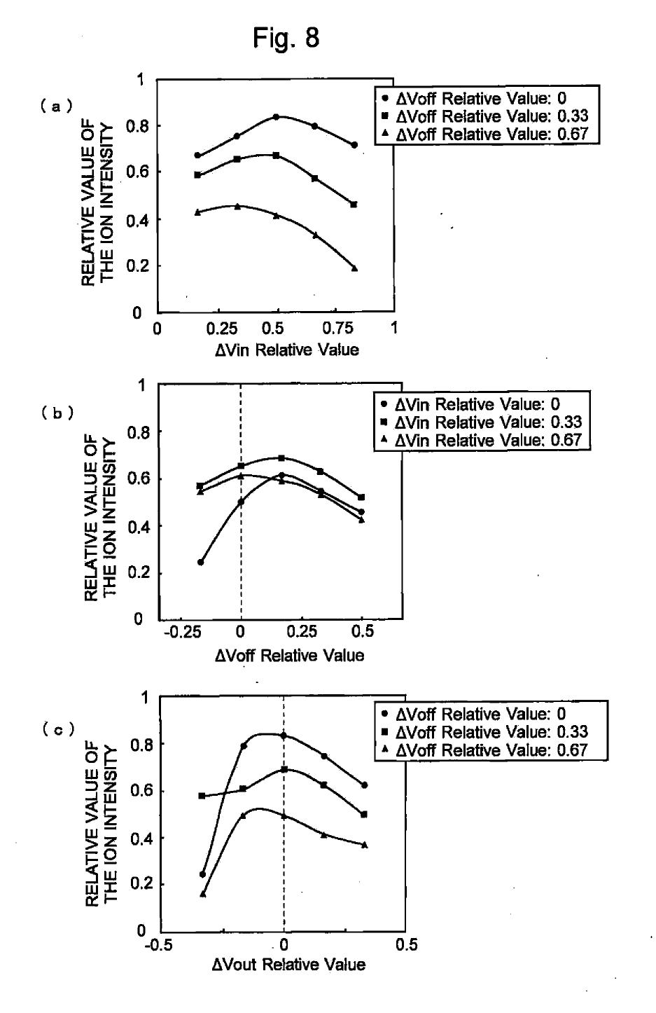

Using an ICP-MS having a configuration corresponding to FIG. 6, an experiment was conducted to measure ion intensities obtained by the detector when the intensities of the direct-current electric fields of the three divided transport regions #1, #2, and #3 of the off-axis ion guide 6 were changed. The results of this measurement are shown in FIG. 8. ΔVin, ΔVoff, and ΔVout are the potential differences (relative values) between both ends of the divided transport regions #1, #2, and #3, respectively. Specifically, FIG. 8(a) shows a measurement result of the relative ion intensity when ΔVin and ΔVoff were changed under the condition that ΔVout was fixed to be zero (relative value). FIG. 8(b) shows a measurement result of the relative ion intensity when ΔVin and ΔVoff were changed under the condition that ΔVout was fixed to be 0.125 (relative value). FIG. 8(c) shows a measurement result of the relative ion intensity when ΔVoff and ΔVout were changed under the condition that ΔVin was fixed to be 0.17 (relative value).

These results show that the optimal relationship among the potential differences ΔVin, ΔVoff, and ΔVout of both ends of the divided transport regions #1, #2, and #3 is ΔVin>ΔVoff>ΔVout. That is, it can be concluded that, given that the intensities of the direct-current electric fields in the ion optical axis C direction of the divided transport regions #1, #2, and #3 are respectively E1, E2, and E3, the optimum magnitude relationship of the intensities of the direct-current electric fields in the ion optical axis C direction is E1>E2>E3˜0.

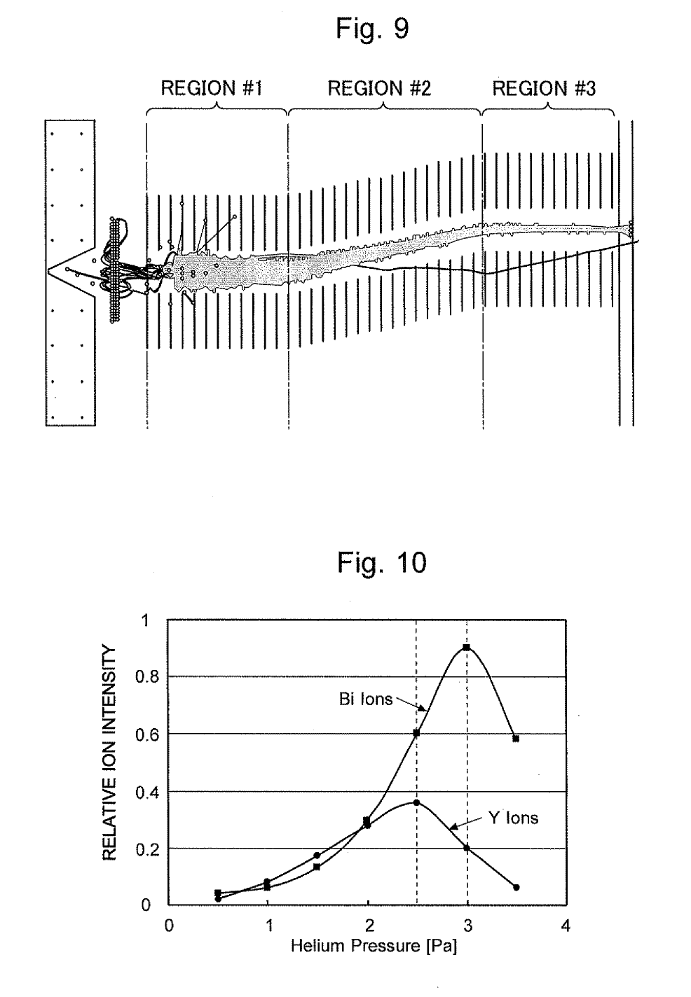

FIG. 9 shows a result of a computer simulation of the orbit of ions in the off-axis ion guide 6 shown in FIG. 7. It was assumed that the ions were cations of Y (yttrium), and ΔVin, ΔVoff, and ΔVout were regulated so as to maximize the ion transport efficiency under the condition of ΔVin>ΔVoff>ΔVout. In addition, the aforementioned potential differences, the gas pressure, the length of the gas region, and other parameters were appropriately adjusted so that the convergence of the ion beam due to the collisional cooling almost finished around the boundary between the second divided transport region #2 and the third divided transport region #3.

From FIG. 9, it can be observed that the ion beam is spatially converged due to the collisional cooling with a cooling gas in the first and second divided transport regions #1 and #2. It can be also seen that the ions converged around the ion optical axis C are transported without being spread in the diametrical direction of the ion beam in the third divided transport region #3 in which the intensity of the direct-current electric field in the ion optical axis C direction is lower than those in the first and second divided transport regions #1 and #2. Further, FIG. 9 shows that the ions that have come in the vicinity of the end point of the third divided transport region #3 are effectively extracted by the electric field formed by the extraction voltage applied to the aperture electrode.

This computer simulation of the ions orbit also confirms that controlling the intensities of the direct-current electric fields as previously described is effective in enhancing the ion transport efficiency.

Since both the aforementioned ion guides 1 and 6 are for converging ions by using a collisional cooling with a cooling gas, the gas pressure of the cooling gas is an important factor for achieving a high level of ion transport efficiency. FIG. 10 shows an examination result of an actual measurement of the relationship between the gas pressure and the detected ion intensity when He was injected as the cooling gas in the configuration of the first embodiment. The ions examined were Y ions and Bi (bismuth) ions. The horizontal axis represents the gas pressure [Pa], and the vertical axis represents the relative ion intensity.

As is understood from this result, there is an optimum range of the gas pressure in terms of the detection sensitivity, and a higher or lower gas pressure than that range decreases the ion transport efficiency, resulting in a decrease in the detection sensitivity. In this example, this optimum gas pressure range is approximately 2 through 3 [Pa]. In the case where the gas pressure is too low, the decrease in the ion transport efficiency probably results from an insufficient collisional cooling in the ion guide and a poor convergence of the ions. Inversely, in the case where the gas pressure is too high, the ion transport efficiency decreases probably because the kinetic energy of the ions is drained too much due to the collisional cooling in the ion guide and the ions cannot be easily extracted from the ion guide. As can be understood from this result, it is preferable to previously examine the appropriate gas pressure range to determine the vacuum evacuation capacity and the amount of cooling gas supply in such a manner that the gas pressure falls within this gas pressure range.

In the aforementioned embodiments, the region in which ions are transported by the ion guide is divided into two or three regions in the ion optical axis C direction. However, it is evident that the ion transport region can be divided into more than three regions and an appropriate electric field can be set for each of the divided regions. It should be noted that the embodiments described thus far are merely an example of the present invention, and it is evident that any modification, adjustment, and addition properly made in accordance with the spirit of the present invention will be included in the scope of the claims of the present application.

What is claimed is:

1. A mass spectrometer including an ion guide for transporting ions through an ion transport region extending from an ion entrance plane to an ion exit plane along an ion optical axis while converging the ions by using a radio-frequency electric field and collisional cooling, wherein the ion transport region is divided into a plurality of divided transport regions, the ion guide forms a direct-current electric field for accelerating the ions, the direct-current electric field has a different potential gradient in an ion optical axis direction for each of the divided transport regions, and an intensity of the direct-current electric field in the divided transport regions decreases as the ions move forward.

2. The mass spectrometer according to claim 1, wherein the ion transport region is divided into N divided transport regions (where N is an integer equal to or more than two), and the intensity of the direct-current electric field in the ion optical axis direction in each of the divided transport regions is set in such a manner that En>En+1 for 1≦n≦N−1 is satisfied given that En is an intensity of the direct-current electric field in the ion optical axis direction in an n^{th} divided transport region from a side of the ion entrance plane.

3. The mass spectrometer according to claim 2, wherein a direct-current electric field in the ion optical axis direction in a divided transport region positioned at a side of the ion exit plane is zero, and ions are extracted from the ion guide by an action of an extraction electric field of an extraction electrode provided at a subsequent stage of the ion guide.

4. The mass spectrometer according to claim 1, wherein:
the ion guide includes an electrode unit provided in an atmosphere in which a cooling gas for the collisional cooling exists and a voltage applier for applying a direct-current voltage to the electrode unit; and
the electrode unit includes virtual multipole rod electrodes in which a plurality of virtual rod electrodes are disposed around the ion optical axis, each of the virtual rod electrodes being composed of a plurality of electrode plates aligned along the ion optical axis.

5. The mass spectrometer according to claim 2, wherein:
the ion guide includes an electrode unit provided in an atmosphere in which a cooling gas for the collisional cooling exists and a voltage applier for applying a direct-current voltage to the electrode unit; and
the electrode unit includes virtual multipole rod electrodes in which a plurality of virtual rod electrodes are disposed around the ion optical axis, each of the virtual rod electrodes being composed of a plurality of electrode plates aligned along the ion optical axis.

6. The mass spectrometer according to claim 3, wherein:
the ion guide includes an electrode unit provided in an atmosphere in which a cooling gas for the collisional cooling exists and a voltage applier for applying a direct-current voltage to the electrode unit; and
the electrode unit includes virtual multipole rod electrodes in which a plurality of virtual rod electrodes are disposed around the ion optical axis, each of the virtual rod electrodes being composed of a plurality of electrode plates aligned along the ion optical axis.

7. The mass spectrometer according to claim 1, wherein:
the ion guide includes an electrode unit provided in an atmosphere in which a cooling gas for the collisional cooling exists and a voltage applier for applying a direct-current voltage to the electrode unit; and
the electrode unit is composed of a plurality of rod electrodes disposed around the ion optical axis, with a resistive layer on a surface of each of the rod electrodes.

8. The mass spectrometer according to claim 2, wherein:
the ion guide includes an electrode unit provided in an atmosphere in which a cooling gas for the collisional cooling exists and a voltage applier for applying a direct-current voltage to the electrode unit; and
the electrode unit is composed of a plurality of rod electrodes disposed around the ion optical axis, with a resistive layer on a surface of each of the rod electrodes.

9. The mass spectrometer according to claim 3, wherein:
the ion guide includes an electrode unit provided in an atmosphere in which a cooling gas for the collisional cooling exists and a voltage applier for applying a direct-current voltage to the electrode unit; and
the electrode unit is composed of a plurality of rod electrodes disposed around the ion optical axis, with a resistive layer on a surface of each of the rod electrodes.

10. The mass spectrometer according to claim 1, wherein:
the ion guide includes an electrode unit provided in an atmosphere in which a cooling gas for the collisional cooling exists and a voltage applier for applying a direct-current voltage to the electrode unit; and
the electrode unit includes a main electrode unit composed of a plurality of rod electrodes for forming a radio-frequency electric field and auxiliary electrodes provided between adjacent rod electrodes of the main electrode unit, the auxiliary electrodes being for generating a direct-current electric field, and the auxiliary electrodes are virtual multipole rod electrodes in which a plurality of virtual rod electrodes are disposed around the ion optical axis, each of the virtual rod electrodes being composed of a plurality of electrode plates aligned along the ion optical axis.

11. The mass spectrometer according to claim 2, wherein:
the ion guide includes an electrode unit provided in an atmosphere in which a cooling gas for the collisional cooling exists and a voltage applier for applying a direct-current voltage to the electrode unit; and
the electrode unit includes a main electrode unit composed of a plurality of rod electrodes for forming a radio-frequency electric field and auxiliary electrodes provided between adjacent rod electrodes of the main electrode unit, the auxiliary electrodes being for generating a direct-current electric field, and the auxiliary electrodes are virtual multipole rod electrodes in which a plurality of virtual rod electrodes are disposed around the ion optical axis, each of the virtual rod electrodes being composed of a plurality of electrode plates aligned along the ion optical axis.

12. The mass spectrometer according to claim 3, wherein:
the ion guide includes an electrode unit provided in an atmosphere in which a cooling gas for the collisional cooling exists and a voltage applier for applying a direct-current voltage to the electrode unit; and
the electrode unit includes a main electrode unit composed of a plurality of rod electrodes for forming a radio-frequency electric field and auxiliary electrodes provided between adjacent rod electrodes of the main electrode unit, the auxiliary electrodes being for generating a direct-current electric field, and the auxiliary electrodes are virtual multipole rod electrodes in which a plurality of virtual rod electrodes are disposed around the ion optical axis, each of the virtual rod electrodes being composed of a plurality of electrode plates aligned along the ion optical axis.

13. The mass spectrometer according to claim 1, wherein:
the ion guide includes an electrode unit provided in an atmosphere in which a cooling gas for the collisional cooling exists and a voltage applier for applying a direct-current voltage to the electrode unit; and
the electrode unit includes a main electrode unit composed of a plurality of rod electrodes for forming a radio-frequency electric field and auxiliary electrodes provided between adjacent rod electrodes of the main electrode unit, the auxiliary electrodes being for generating a direct-current electric field, and the auxiliary electrodes are a plurality of rod electrodes disposed around the ion optical axis, with a resistive layer on a surface of each of the auxiliary electrodes.

14. The mass spectrometer according to claim 2, wherein:
the ion guide includes an electrode unit provided in an atmosphere in which a cooling gas for the collisional cooling exists and a voltage applier for applying a direct-current voltage to the electrode unit; and
the electrode unit includes a main electrode unit composed of a plurality of rod electrodes for forming a radio-frequency electric field and auxiliary electrodes provided between adjacent rod electrodes of the main electrode unit, the auxiliary electrodes being for generating a direct-current electric field, and the auxiliary electrodes are a plurality of rod electrodes disposed around the ion optical axis, with a resistive layer on a surface of each of the auxiliary electrodes.

15. The mass spectrometer according to claim 3, wherein:
the ion guide includes an electrode unit provided in an atmosphere in which a cooling gas for the collisional cooling exists and a voltage applier for applying a direct-current voltage to the electrode unit; and
the electrode unit includes a main electrode unit composed of a plurality of rod electrodes for forming a radio-frequency electric field and auxiliary electrodes provided between adjacent rod electrodes of the main electrode unit, the auxiliary electrodes being for generating a direct-current electric field, and the auxiliary electrodes are a plurality of rod electrodes disposed around the ion optical axis, with a resistive layer on a surface of each of the auxiliary electrodes.

16. The mass spectrometer according to claim 1, wherein:
the ion guide is an off-axis ion optical system in which an ion optical axis at the ion entrance plane and an ion optical axis at the ion exit plane are out of alignment, and at least one of the divided transport regions is an off-axis transport region.

17. The mass spectrometer according to claim 2, wherein:
the ion guide is an off-axis ion optical system in which an ion optical axis at the ion entrance plane and an ion optical axis at the ion exit plane are out of alignment, and at least one of the divided transport regions is an off-axis transport region.

18. The mass spectrometer according to claim 3, wherein:
the ion guide is an off-axis ion optical system in which an ion optical axis at the ion entrance plane and an ion optical axis at the ion exit plane are out of alignment, and at least one of the divided transport regions is an off-axis transport region.
